(19) United States
(12) Patent Application Publication
(10) Pub. No.: US 2004/0128888 A1
(43) Pub. Date: Jul. 8, 2004

(54) Deployable alert--rescue system to produce readly recognizable distinctive mien

(76) Inventors: Ruben Payan, Phoenix, AZ (US); Ricardo C. Lopez, Avondale, AZ (US)

Correspondence Address: TOD R. NISSLE, P.C., P.O. Box 55630, Phoenix, AZ, 85078, US

(21) Appl. No.: 10/326,819

(22) Filed: Dec. 20, 2002

(51) Int. Cl. G09F 15/00

(52) U.S. Cl. 40/610

(57) ABSTRACT

An alert device is provided that includes a light producing surface, The alert device has a stored configuration in which the light producing surface is compacted and the visible area of the light producing surface is decreased. The alert device also has a deployed configuration in which the visible area of the light producing surface is increased. A microprocessor is used to control light producing elements on the light producing surface to produce desired symbols.

This invention pertains to alert and rescue systems.

More particularly, the invention pertains to an alert-rescue system in which a vehicle comprises one of the visual cues used to produce a distinctive mien that is readily recognized by a driver in an approaching vehicle.

In another respect, the invention pertains to an alert-rescue system in which an alert device is combined with the trunk of a vehicle to produce a distinctive profile that makes a driver in an approaching vehicle cognizant of the presence of the vehicle.

In a further respect, the invention pertains to an alert-rescue system in which a vehicle is utilized to produce a backdrop that frames and increases the visibility of light emanating from an alert device that is in or adjacent the vehicle.

In still another respect, the invention pertains to an alert-rescue system in which an alert device includes a pliable-light producing panel that can be readily reduced from an extended deployed configuration into a compact storage configuration.

In still a further respect, the invention pertains to an alert-rescue system in which a vehicle is employed to position an alert device at a selected elevation above the ground.

In yet another respect, the invention pertains to an alert-rescue system including a panel in which electromagnetic radiation emanating from the panel includes radiation having approximately a wavelength in the range of 3900 angstroms to 7700 angstroms and is produced by reflection, by refraction, or by exciting atoms chemically, electrically, with heat, or with other forms of energy.

In yet a further respect, the invention pertains to an alert-rescue system that can be utilized either with a vehicle or separately from a vehicle.

It is a dangerous proposition for an individual to exit or walk along side a vehicle stopped at the side of a road. Oncoming traffic can strike and injure the individual. As a result, a variety of alert devices have been designed to alert oncoming traffic of the presence of the stopped vehicle. Existing alert devices typically include reflective material that enables oncoming traffic to see the devices at night. One existing alert device is shaped like a triangle, is about one to two feet high, and, in use, is placed on the ground behind a vehicle when the vehicle is stopped at the side of a road. Certain circumstances limit the effectiveness of these “triangle” alert devices and other such devices. During daylight hours the reflective material is not particularly noticeable to an oncoming driver, and the proximity of the alert device to the ground can make it difficult for an oncoming driver to see, particularly if the driver is traveling toward the sun during sunrise or sunset, or if the background behind the alert device has a coloring similar to that of the alert device.

Accordingly, It would be highly desirable to provide an alert-rescue system that would increase the likelihood that the driver of an oncoming vehicle would recognize the alert device well prior to reaching a stopped vehicle.

Therefore, it is a principal object of the invention is to provide an improved alert-rescue system for use both in conjunction with a vehicle and in other applications.

Another object of the invention is to provide an improved alert-rescue system that increases the likelihood that the driver of an approaching vehicle will notice a stopped vehicle well prior to reaching the stopped vehicle.

A further object of the invention is to provide an improved alert-rescue system that makes use of the profile of a stopped vehicle.

Still another object of the invention is to provide an improved alert-rescue system that can be utilized either with or separately from a vehicle.

Yet another object of the invention is to provide an improved alert-rescue system that can be used to facilitate the rescue of a lost or stranded individual or group of individuals.

These and other, further and more specific objects and advantages of the invention will be apparent from the following detailed description of the invention, taken in conjunction with the drawings, in which:

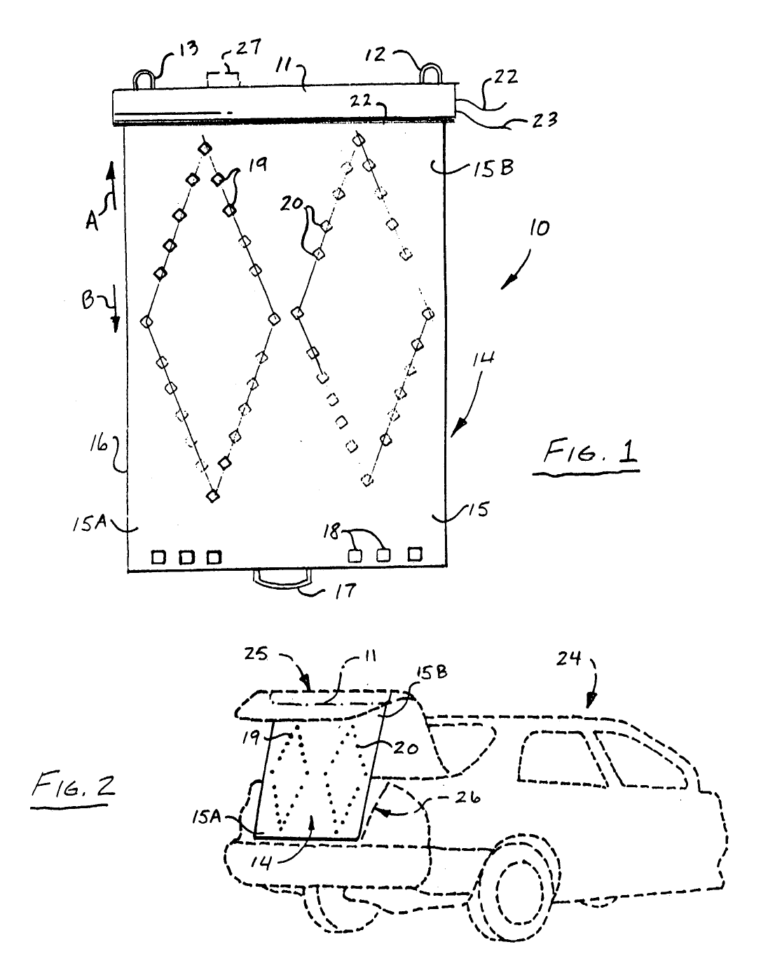

FIG. 1 is a front elevation view illustrating an alert device constructed in accordance with the principles of the invention;

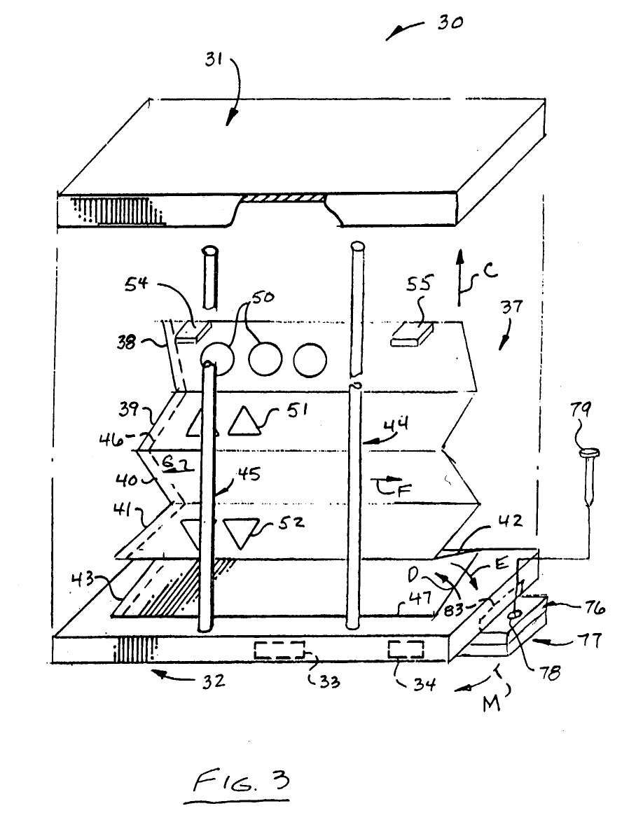

FIG. 2 is a perspective view illustrating an early warning system constructed in accordance with the invention;

FIG. 3 is a perspective view illustrating another alert device constructed in accordance with the principles of the invention;

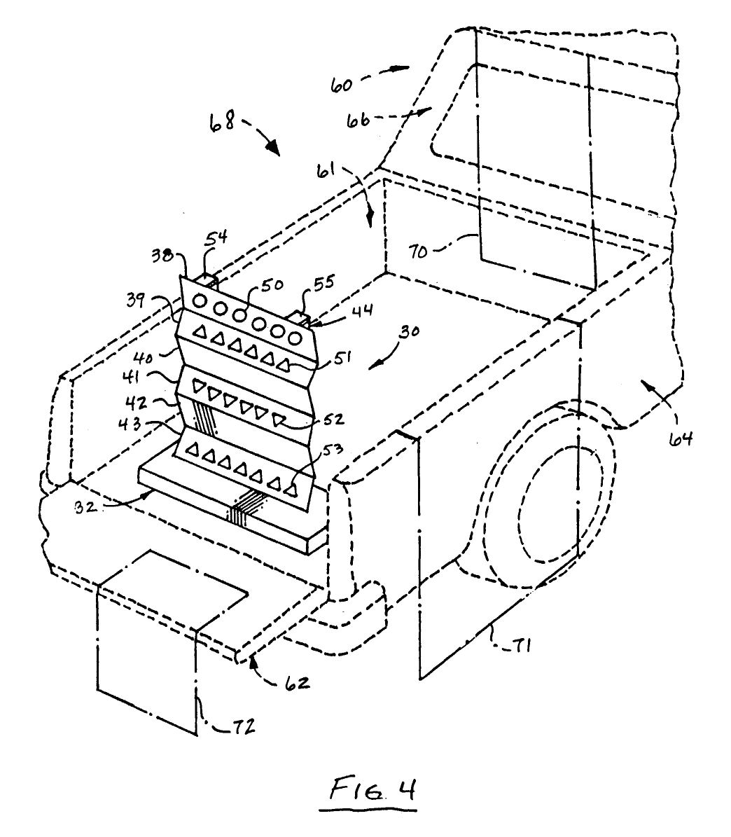

FIG. 4 is a perspective view illustrating an early warning system constructed in accordance with the invention and utilizing the alert device of FIG. 3;

FIG. 5 is a perspective view illustrating a support stand that is utilized in one embodiment of the invention; and,

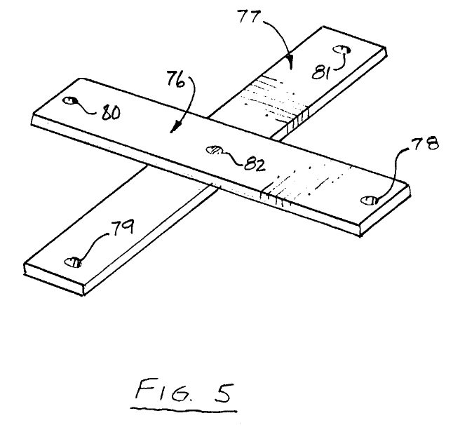

FIG. 6 is a top view illustrating an alternate embodiment of the alert-rescue device of the invention in a deployed configuration;

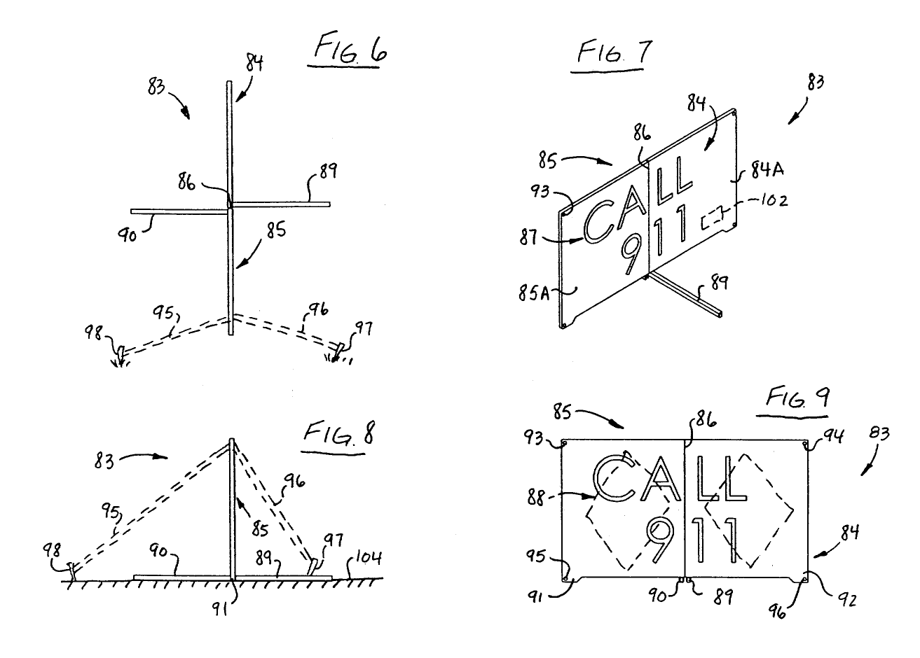

FIG. 7 is a perspective view illustrating the deployed alert-rescue device of FIG. 6;

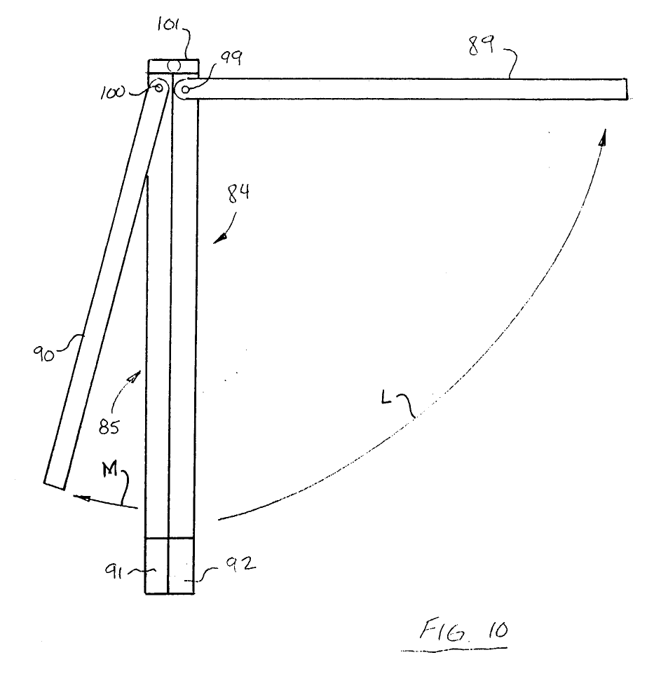

FIG. 8 is a side view illustrating the deployed alert-rescue device of FIG. 9;

FIG. 9 is a front elevation view illustrating the deployed alert-rescue device of FIG. 7; and,

FIG. 10 is a bottom view illustrating the alert-rescue device of FIG. 7 with the panels in the folded stored configuration and illustrating the mode of operation of the pivoting support feet.

Briefly, in accordance with our invention, we provide an improved deployable alert device including a light producing surface having at least two operative positions, a first stored operative position for transport of the alert device, the light producing surface being in a compacted configuration in the first operative position; and, a second deployed operative position in which the light producing surface is deployed from the compacted configuration into an expanded configuration that increases the visible surface area of the light producing surface in comparison to the visible area of the light producing surface in the first operative position.

In another embodiment of our invention, we provide a deployable alert device including a surface including light producing components; and, a system for controlling the light-producing components to produce a plurality of different symbols.

In a further embodiment of our invention, we provide an improved deployable alert system. The system includes a vehicle. The vehicle includes a body having a profile when viewed in daylight from the rear of the vehicle; a motor mounted on the body to provide motive power to move the vehicle; and, a trunk including a bottom elevated above the ground and a door. The door has at least two operative positions, a first closed operative position, and a second open operative position. The door is in the second open operative position. The system also includes an alert device having at least two operative positions, a first stored operative position for transport of the alert device, and a second deployed operative position elevated above the ground in the trunk in which the device extends above the bottom of the trunk and has a silhouette extending around the alert device. At least a portion of the silhouette is visible when viewed in daylight from the rear of the vehicle. The portion of the silhouette and the profile having in combination when viewed from the read of the vehicle a distinctive mien.

In still another embodiment of the invention, we provide an improved method to provide an alert system. The method includes the step of providing a vehicle. The vehicle includes a body having a profile when viewed in daylight from the rear of the vehicle; a motor mounted on the body to provide motive power to move said vehicle; and, a trunk including a bottom elevated above the ground and a door. The door is movable between at least two operative positions, a first closed operative position, and a second open operative position. The door is in the first operative position. The method also includes the step of providing an alert device that is adjustable between at least two operative configurations, a first stored operative configuration for transport of the alert device, and a second deployed operative configuration elevated above the ground in the trunk in which the device extends above the bottom of the trunk and has a silhouette extending around the alert device. At least a portion of the silhouette is visible when viewed in daylight from the rear of the vehicle. The device is in the first operative configuration. The method also includes the steps of storing the alert device in the vehicle in the first stored operative configuration; driving the vehicle to a selected location; positioning the vehicle such that the trunk door is visible to the drivers of vehicles approaching from the rear of the vehicle; moving the trunk door to the second open operative position; and, adjusting the alert device in the trunk to the second deployed operative configuration elevated above the ground such that the portion of the silhouette and the profile are visible to drivers in vehicles approaching from the rear of the vehicle.

In still a further embodiment of the invention, we provide a deployable alert device including a light producing surface. The device has at least two configurations, a first configuration for storage, and a second deployed configuration. The device includes a light producing surface operable to produce at least two messages, a first message including an action symbol, and, a second message identifying the presence of the alert device without including an action symbol.

In yet another embodiment of the invention, we provide a deployable alert device including at least one panel; a surface on the panel including light producing components; a system for controlling the light-producing components to produce at least one symbol; a plurality of elongate support members each having first and second ends; first fasteners for securing the first ends to the panel; and, second fasteners for securing the second ends to a support surface.

Turning now to the drawings, which depict the presently preferred embodiments of the invention for the purpose of illustrating the practice thereof and not by way of limitation of the scope of the invention, and in which like reference characters refer to corresponding elements throughout the several views, FIG. 1 illustrates an alert device generally indicated by reference character 10 and including a hollow elongate cylindrical housing 11 having an elongate slot 22 through which thin pliable panel 14 extends. The leading edge (not visible) of the upper end 15B of panel 14 is attached to an elongate rod (not visible). The rod is rotatably positioned inside housing 11 and extends along the longitudinal centerline of the housing. A motor (not visible) turns the rod in two directions. When the rod is turned in one direction, panel 14 is deployed from housing 11 downwardly in the direction of arrow B. When the rod is turned in the other direction, panel 14 is drawn through slot 22 into housing 11 and wraps around the rod in a storage configuration. In other words, panel 14 is deployed from and drawn into housing in the same manner as conventional ceiling-mounted movie screens found in schools, auditoriums, etc. Such movie screen include a pliable panel that is drawn or retracted into a cylindrical housing for storage and that is deployed downwardly from the housing in a vertical orientation so the panel can be used as a movie screen. In such conventional ceiling-mounted movie screens, a motor turns a rod in the cylindrical housing to deploy or retract the pliable movie screen panel.

In FIG. 1, panel 14 includes magnets 18 attached along the bottom end 15A of panel 14 and includes light producing or emitting elements 19 and 20. Elements 19 and 20 can comprise reflectors, refractors, LED's, fluorescing materials, reflective paint, or any other components or materials that produce light. A light producing component can produce light by generating light (as would an LED or light bulb), by reflecting light received from another source (which source could, for example, be the headlights of an approaching vehicle, be the sun, or be the moon), by refracting light received from another source, by focusing light (as would a lens) received from another source, by scattering or diverging light beams received from another source, by delivering light from another source (as would an optical fiber) or by any combination of the foregoing. Elements 19 and 20 can be fabricated to be seen at night and/or during the day. When elements 19 comprise LED's or other components that require electricity to produce light, wiring or other electrical connections are formed on panel 14 and interconnect the elements 19 with a battery, solar-powered panel, or other source of electricity. The battery 27 can be mounted on housing 11, on panel 14, or at some location separate from alert device 10. Hooks or hangers 12, 13 are attached to the top of housing 11. As is illustrated in FIG. 2, hooks 12, 13 are mounted on screws, or other fasteners attached to the inside of the door 25 of the trunk 26 of a vehicle 24 so that panel 14 can be deployed downwardly from housing 11 and door 25 in the manner shown. Any other means can be utilized to secure removably or fixedly housing 11 to the underside of door 25. When door 25 is in the open position shown in FIG. 2 and housing 11 is mounted on the underside of door 25, panel 14 is deployed by grasping handle 17 and pulling panel 14 downwardly in the direction of arrow B to the position shown in FIG. 2. Magnets 18 at the bottom end 15A of panel 14 attach to metal in vehicle 24 at the bottom of trunk 26 to secure panel 14 in the configuration illustrated in FIG. 2. The magnets 18 enable panel 14 to be readily removed from vehicle 24. Alternatively, housing 11 can be secured to the bottom of trunk 26 such that panel 14 is deployed by grasping handle 17 and pulling panel 14 upwardly in the direction of arrow A to use magnets 18 to secure end 15A to the underside of door 25.

In one embodiment of the invention, housing 11 is eliminated and only panel 14 is provided. Hooks or other fastening means are attached to the top 15B of panel 14. The hooks attach to hooks or other fasteners on the underside of door 25. Magnets 18 attach the lower part 15A of panel 14 to the lower part of trunk 26 such that panel 14, when installed in trunk 26, still has the general deployed configuration illustrated in FIG. 2.

An alternate alert device 30 is illustrated in FIG. 3 and includes base 32 and top or lid 31. If desired, lid 31 can be omitted. Base 32 can be stored without a cover. Or, base 32 can be stored in a bag, covered with a piece of fabric, or stored using any other desired protective material or system. Panel 37 includes a plurality of articulating panel members 38 to 43. Members 38 to 43 are interconnected or hinged together such that panel members 38 to 43 fold and unfold in accordion fashion. The lower edge 47 of panel member 43 is hinged or attached to base 32 such that edge 47 remains adjacent base 32 but pivots with respect to base such that panel member 43 can pivot up and down from base 32 in the manner indicated by arrows D and E, i.e., such that panel member 43 can move in accordion fashion along with the other panel members 38 to 42.

Rigid tabs 54 and 55 are fixedly secured to and extend outwardly from the top of member 38. After panel 37 is pulled upwardly in the direction of arrow C to the position illustrated in FIG. 4, rod 44 is moved in the direction of arrow F (FIG. 3) to a position extending between tab 55 and base 32. When rod 44 is in this position, tab 55 rests on top of rod 44 in the manner illustrated in FIG. 4. Rod 44 supports tab 55 and maintains panel 37 in the deployed configuration shown in FIG. 4. Similarly, rod 45 is moved in the direction of arrow G to a position in which rod 45 extends between tab 54 and the top of base 32. Rod 45 supports tab 54 to maintain panel 37 in the deployed configuration shown in FIG. 4. When device 30 is adjusted to the stored configuration, rods 44 and 45 are removed, and panels 38 to 43 are allowed to collapse under the force of gravity and to fold and stack one on top of the other. Lid 31 is then placed on base 32 to enclose folded panels 38 to 43.

As would be appreciated by those of skill in the art, alert device 30 can be constructed in any manner. For example, rods 44 and 45 can be telescoping rods that are secured with set screws or other means in an extended position. Any other structural member or members can be utilized to perform the function of maintaining panel 37 in a deployed orientation in which the light producing elements 50 to 53 are visible. Base 32 can include storage slots or brackets for engaging and storing rods 44 and 45. Panel 37 need not be constructed in accordion fashion and, instead, can, for example, be a continuous pliable panel like panel 14 and can be folded or rolled up for storage. It is primarily required that a panel be provided that can be mounted in the trunk of a vehicle or on or in another desired portion of a vehicle. It is also preferred, but not required, that the panel 14 be collapsible from a deployed configuration and to a storage configuration in which the space occupied by the panel is reduced to facilitate transport of the panel.

Wiring 46 interconnects battery 33 and LEDs or other light producing components that comprise light producing elements 50 to 53 and are mounted on or in panel member 38 to 43. In FIGS. 3 and 4, each element 50 to 53 extends completely through the panel member 38 to 43 in which the element 50 to 53 is mounted. A light producing element 50 to 53 can include one or more LEDs, reflectors, refractors, lens, or other light producing components. As noted above, a light producing component produces light by generating light (as would an LED or light bulb), by reflecting light received from another source (which source could, for example, be the headlights of an approaching vehicle, be the sun, or be the moon), by refracting light received from another source, by focusing light (as would a lens) received from another source, by scattering or diverging light beams received from another source, by delivering light from another source (as would an optical fiber) or by any combination of the foregoing. One surface 15 of a panel 14 (FIG. 1), 37 (FIG. 3) can include one kind of light producing component while the opposing surface 16 of a panel 14, 37 can include another different kind of light producing component. As noted above, the light producing component can refract light. Also, as noted, the light producing component can, when it is producing light, be visible at night and/or during the day. For example, one side 15 can include an LED while the other side 16 includes a reflector. Connector 34 can receive an extension cord, cord from the cigarette lighter of a vehicle, or other electrical connector to charge battery 33 and/or to power LEDs or other electrically driven light producing elements on a panel 37. Connector 34 (FIG. 3) can include a microprocessor that can send signals to LEDs or other light producing components to selectively activate such components so that only certain ones of the components are producing light at any given time. When LEDs or other light producing components can be selectively activated, then an array of LEDs or other light producing components can be used to produce symbols that can be seen and read by the drivers of oncoming traffic approaching from the rear of a vehicle in which an alert device 10, 30 is mounted. For example, an array of LEDs can produce the numbers 911 or another warning symbol or symbols. The microprocessor can be mounted on an alert device 10, 30 or can be located remote from the alert device 10, 30 and communicate with alert device 10, 30 via any desired means including, but not limited to, microwave transmission, radio transmission, infrared transmission, and transmission over a hard wired connection.

As noted below, an alert device 10, 30 can be positioned at various locations on a vehicle. The location of the alert device determines the direction from which the alert device can be viewed. For example, In FIG. 4 an alert device placed on the side 64 of a vehicle 68 at the location indicated by dashed lines 71 ordinarily can not be seen by a driver in a vehicle approaching from the rear of vehicle 68 but can be seen by a driver approaching side 64.

In FIG. 4, alert device 30 is deployed and mounted in the trunk (i.e., the bed) of a vehicle with the door 62 of the trunk open. As used herein, trunk indicates a storage compartment at the rear of a vehicle that is accessed by opening a door located at the rear of the vehicle. Therefore, the bed of a pickup truck is termed a trunk and, in a van, the rear portion of the van is termed a trunk when accessed via a door at the back of the van.

As used herein, vehicle refers to standard sized vehicles that ordinarily travel on public streets and freeways. Consequently, vehicles include, for example, passenger cars, pickup trucks, moving vans, vans, and mini-vans. The term vehicles does not refer to large mining or earth moving equipment like graders and the very large oversized dump trucks found in mining operations. As used herein, oversized vehicle refers to vehicles other than standard sized vehicles. The alert device of the invention can, if desired, be utilized with oversized vehicles.

The mien created by the alert system of the invention is critical in the practice of one embodiment of the invention. The system of the invention has a distinctive appearance that makes it more likely that the warning system will be seen and recognized by a driver approaching the early warning system. An important part of the mien of the system is the silhouette or profile, i.e. the outline, of the vehicle in which the alert device is mounted. As used herein, the alert system is distinctive if its appearance and/or location is not normally encountered by a driver in day-to-day driving. For example, a vehicle stopped at the side of a road with its trunk up is distinctive because it is not something a driver routinely sees during day-to-day driving. A vehicle at the side of the road is distinctive because vehicles are not normally pulled over to the side of a road. A pick-up truck stopped with its tailgate down at the side of a public thoroughfare is distinctive because this is not something a driver routinely sees during day-to-day driving. A vehicle can be utilized in combination with any alert system. Even a flashlight or reflective triangle, for example, mounted on a vehicle at night produces a distinctive appearance not normally encountered by an oncoming driver or individual.

Consequently, the profile created when the trunk of a vehicle is open is unusual, and distinctive. It is also significantly larger than the profile of conventional warning devices, i.e. reflective warning triangles, placed on the road behind a stopped vehicle.

Another important feature in creating an alert system with a distinctive mien is combining an alert device with a vehicle by placing the alert device in the trunk of a vehicle or some other location on the vehicle, particularly when the vehicle functions to elevate the alert device. An alert device 10, 30 can, if desired, be placed directly on or extend up from the ground adjacent or near a vehicle in the same manner that conventional warning devices like reflective warning triangles are placed on the ground adjacent or near a vehicle. The appearance created, however, by placing an alert device in a trunk 26 such that the device is recessed in the trunk 26 and is circumscribed at least in part by the trunk 26 is a preferred embodiment of the invention because light emanating from inside the trunk is an unusual site. The trunk also tends to block external light such that an oncoming motorist can more readily make out light emanating from an alert device 10, 30. As would be appreciated by those of skill in the art, the trunk must be open a sufficient distance and the alert device must be positioned in the trunk such that on approaching motorist can view light emanating from the alert device.

An alert device can, in addition to being placed in the trunk of a vehicle, be placed at other locations on the vehicle as indicated by dashed lines 70 to 72 in FIG. 4. An alert device 10, 30 can also be placed on the roof or hood of a vehicle, under a vehicle, on the tire of a vehicle, on the front grill of a vehicle, or at any other desired location on a vehicle. Further, an alert device 10, 30 can be used separately from a vehicle. For example, an alert device 10, 30 can be carried by a hiker, by a group of campers, or by any other desired individual or group of individuals. The alert device can be used in time of emergency or at any other desired time. An alert device 10, 30 can be stored in a building structure or other desired location and can be used in time or emergency or at any other desired time.

Base 32 can, if desired, include a stand. The stand, illustrated in FIGS. 3 and 5, includes leg 76 fixedly secured to based 32, and includes a leg 77 pivotally attached to leg 76 by pivot pin 82 extending through legs 76 and 77. When device 30 is stored, legs 76, 77 are in the parallel orientation illustrated in FIG. 3. When device 30 is deployed, leg 77 is pivoted in the direction of arrow M (FIG. 3) to the orientation illustrated in FIG. 5. Leg 76 can, if desired, be inset in base 32 in the manner indicated by dashed lines 83 in FIG. 3. Openings 79 to 81 formed in the distal ends of legs 76, 77 are shaped and dimensioned to receive tent stakes 79 or other fasteners to secure legs 76, 77 in a desired position to and on the ground.

When panel 14 is retracted or wound into housing 11 (FIG. 1), panel 14 is in a stored operative position which facilitates transport of device 10, and, the light producing surface 15 and the light producing elements 19 and 20 are in a compacted configuration in which surface 15 is not visible. When handle 17 is pulled in the direction indicated by arrow B and panel 14 is deployed to the operative position and orientation illustrated in FIG. 1, light producing surface 15 is deployed from the compacted configuration into the expanded configuration illustrated in FIG. 1. In the expanded configuration, the visible surface area of the light producing surface 15 is increased in comparison to the area of the light producing surface 15 that is visible when surface 15 is in the compacted configuration.

When panel 37 is folded in a direction opposite that of arrow C in FIG. 3 into a stored operative position which facilitates transport of device 30, and, the light producing surface and the light producing elements 50 to 52 are in a compacted configuration in which the light producing surface is not visible. When panel 37 is unfolded in the direction of arrow C and is deployed to the operative position and orientation illustrated in FIG. 4, the light producing surface of panel 37 is deployed from the compacted configuration into the expanded configuration illustrated in FIG. 4. In the expanded configuration, the visible surface area of the light producing surface of device 30 is increased in comparison to the area of the light producing surface that is visible when the light producing surface is in the folded compacted configuration. It is understood that the light producing surface of an alert device 10, 30 can be compacted in a manner in which a portion of the light producing surface is visible. Regardless, however, of how the light producing surface is compacted, once the light producing surface is deployed in an expanded configuration, the visible area of the light producing surface is increased.

In use, an alert device 10, 30 is transported or stored in a stored operative position or configuration. During an emergency, or at any other desired time, the alert device is used in a deployed operative position or configuration by deploying the light producing surface in the manner described above. If necessary, electricity or other means is provided to cause light producing elements 50 to 52, 19, 20 to produce light. Or, device 10, 30 is positioned such that light producing elements 50 to 52 receive and process light (i.e., by reflecting the light, refracting the light, focusing the light, scattering the light, etc.). A microprocessor or other means can be utilized to selectively activate all or a portion of the light producing elements on a light producing surface to produce “911” or some other desired symbol or symbols. For example, if an LED array is used on a light producing surface and the LED array forms a rectangular grid, the microprocessor can activate some of the LEDs to produce light and allow the remaining LEDs to not produce light and to remain “dark”. The LEDs that produce light form a number(s), letter(s), or other symbol in much the way that scoreboard or display boards at football stadium and other athletic events selectively form numbers and letters. As used herein, symbol includes alphanumeric characters and combinations thereof, includes known recognizable objects (i.e., an animal, a cross, a star, a building, a rainbow, a series of morse code dots and dashes, a flag, etc.), includes words, and includes unrecognizable designs comprised of lines, shapes, and/or colors (i.e., several circles randomly placed on the LED display).

The embodiment of the alert device 83 of the invention illustrated in FIGS. 6 to 10 includes panels 84 and 85, light producing surface 84A on panel 84, light producing surface 85A on panel 85, fixed feet 91 and 92, pivoting adjustable feet 89 and 90, symbol patterns or messages 87 and 88, apertures 91 to 94, and pins 99, 100 (FIG. 10) pivotally securing feet 89 and 90 to the bottom of panels 84 and 85, respectively.

Apertures 91 to 94 are used to secure alert device 83 in an upright orientation. One end of elongate support member 95 is fastened to panel 85 using aperture 93. If member 95 (or 96) is, for example, a pliable length of rope, aperture functions as a fastener since one end of member 95 is threaded through aperture 93 to tie the end of member 95 to panel 85. The other end of member 95 (or opposing member 96) is secured to a stake 98 (or 97) in the ground to tension member 95. If member 95 is, for example, a bungee cord, the hook at one end of the bungee cord is latched through aperture to panel 85. The hook at the other end of the bungee cord is secured around a stake 98 or other fastener. Hooks or other fasteners can be utilized on panel 85 instead of or in conjunction with apertures 91 to 94. Apertures 91 to 94 function as fasteners. Member 95 can, if desired, be rigid and, for example, can comprise a rod. One advantage of the embodiment of the invention illustrated in FIGS. 6 to 10 is that feet 89 and 90 need not be used and that guy lines or other support members 95, 96 can be used to secure device 83 in the upright orientation illustrated in FIGS. 7 and 9. A panel 84 can include a battery 102 to power LEDs or other light producing components mounted on surfaces 84A and 85A of panels 84, 85. Electricity or other energy to power LEDs or other light producing components can be supplied by a connection to a vehicle cigarette lighter or from any other desired source. A switch (not shown) can be included on a panel 84, 85. When the switch is in one position, LEDs are illuminated that produce message 87 “CALL 911” on panels 84, 85. When the switch is in a second position, message 87 is not produced on panels 84, 85 but—instead—LEDs are illuminated to produce message 88 (i.e., the double diamond pattern) on panels 84, 85. The user operates the switch to elect which message 87, 88 appears on panels 84, 85.

FIG. 10 illustrates the pins 99, 100 that pivotally attach legs 89, 90, respectively, to the bottoms of panels 84, 85, respectively. Leg 89 pivots outwardly in the direction of arrow L from the storage position of leg 89 adjacent and parallel the bottom of panel 84. Leg 90 pivots outwardly in the direction of arrow M from the storage position of leg 89 adjacent and parallel the bottom of panel 85. Panels 84, 85 are in their folded storage configuration in FIG. 10. In FIGS. 7 and 9, panels 84, 85 have been unfolded from the storage configuration of FIG. 10 to the configuration shown in FIGS. 7 and 9. Hinge 101 pivotally interconnects parallel opposed edges of panels 84 and 85 in conventional fashion.

In FIG. 7, the light producing components on surfaces 85A and 84A produce a message 87 that includes the symbols “CALL” and “911”. The symbol “CALL” is an action symbol because it suggests or requests that a person viewing the message take an action. Examples of other action symbols are, without limitation, the word “HELP”, the word “BRING” (as in “BRING WATER”), and, morse code that spells such an action symbol.

As indicated by dashed lines 88 in FIG. 9, the light producing components on surfaces 85A and 84A can produce a message comprising a pair of diamond shaped symbols in the place of and instead of the symbols “CALL” and “911”. The diamond shaped alert symbols function to identify the presence and location of the alert device 83. In contrast, however, to the message “CALL 911”, the message comprised of the diamond shaped symbols does not include an action symbol and does not function to suggest or request that a person viewing the message take an action. Other examples of alert symbols generally include, without limitation, single letters or numbers. Symbols that suggest or request an action by a person viewing the symbol are termed action symbols. Alert symbols are symbols that by their mere presence on an alert device alert a viewer of the presence of the alert device but that do not suggest or request an action by a person viewing the alert device.

Having described our invention in such terms as to enable those of skill in the art to make and practice it, and having described the presently preferred embodiments thereof, we claim:

1. A deployable alert device including a light producing surface having at least two operative positions,
(a) a first stored operative position for transport of said alert device, said light producing surface being in a compacted configuration in said first operative position; and,
(b) a second deployed operative position in which said light producing surface is deployed from said compacted configuration into an expanded configuration that increases the visible surface area of said light producing surface in comparison to the visible surface area of said light producing surface in said compacted configuration.

2. A deployable alert device including
(a) a surface including light producing components; and,
(b) a system for controlling said light-producing components to produce a plurality of different symbols.

3. A deployable alert system including
(a) a vehicle including
(i) a body having a profile when viewed in daylight from the rear of the vehicle,
(ii) a motor mounted on the body to provide motive power to move said vehicle, and
(iii) a trunk including a bottom elevated above the ground and a door, said door having at least two operative positions,
a first closed operative position, and
a second open operative position,
said door being in said second open operative position;
(b) an alert device having at least two operative positions,
(i) a first stored operative position for transport of said alert device, and
(ii) a second deployed operative position elevated above the ground in said trunk in which said device extends above said bottom of said trunk and has a silhouette extending around said alert device, at least a portion of said silhouette being visible when viewed in daylight from the rear of said vehicle,
said portion of said silhouette and said profile having in combination a distinctive mien

4. A method to provide an alert system, comprising the steps of
(a) providing a vehicle including
(i) a body having a profile when viewed in daylight from the rear of the vehicle,
(ii) a motor mounted on the body to provide motive power to move said vehicle, and
(iii) a trunk including a bottom elevated above the ground and a door, said door being movable between at least two operative positions,
a first closed operative position, and
a second open operative position,
said door being in said first operative position
(b) providing an alert device being adjustable between at least two operative configurations,
(i) a first stored operative configuration for transport of said alert device, and
(ii) a second deployed operative configuration elevated above the ground in said trunk in which said device extends above said bottom of said trunk and has a silhouette extending around said alert device, at least a portion of said silhouette being visible when viewed in daylight from the rear of said vehicle,
said device being in said first operative configuration;
(c) storing said alert device in said first stored operative configuration in said vehicle;
(d) driving said vehicle to a selected location along a public thoroughfare and stopping the vehicle at the side of the public thoroughfare;
(e) positioning said vehicle such that said trunk door is visible to the drivers of vehicle approaching from the rear of said vehicle;
(f) moving said trunk door to said second open operative position;
(g) adjusting said alert device to said second deployed operative configuration in said trunk elevated above the ground such that said portion of said silhouette and said profile are visible to drivers in vehicles approaching from the rear of said vehicle.

5. A deployable alert device including a light producing surface, said device having at least two configurations,
(a) a first configuration for storage;
(b) a second deployed configuration;
said device including a light producing surface operable to produce at least two messages,
(c) a first message including an action symbol; and,
(d) a second message identifying the presence of the alert device without including an action symbol.

6. A deployable alert device including
(a) at least one panel;
(b) a surface on said panel including light producing components;
(c) a system for controlling said light-producing components to produce at least one symbol;
(d) a plurality of elongate support members each having first and second ends;
(e) first fasteners for securing said first ends to said panel; and,
(f) second fasteners for securing said second ends to a support surface.
